(19) United States
(12) Patent Application Publication
(10) Pub. No.: US 2013/0097918 A1
(43) Pub. Date: Apr. 25, 2013

(54) INSECT TRAP

(71) Applicant: Andrew Coventry, Burleigh Heads (AU)

(72) Inventor: Andrew Coventry, Burleigh Heads (AU)

(73) Assignee: BANTIX WORLDWIDE PTY LTD., Burleigh Heads, Queensland, AU (AU)

(21) Appl. No.: 13/640,098

(22) PCT Filed: Apr. 1, 2011
(86) PCT No.: PCT/AU2011/000381

§ 371 Date: Dec. 18, 2012

(30) Foreign Application Priority Data
Apr. 7, 2010 (AU) 2010901464
Dec. 6, 2010 (AU) 2010905306

(51) Int. Cl. A01M 1/10

(52) U.S. Cl. CPC A01M 1/106
USPC 43/107; 137/561 R; 137/14; 43/113

(57) ABSTRACT

The invention provides an insect trap including a housing having located therein a gas bottle or container, one or more modulators having a viscous medium to produce a pulsed flow of gas and a capillary tube interconnecting the gas bottle or container and a respective modulator; a conduit assembly interconnecting a modulator at one end and connectable to a gas bottle or container at another end; an attachment body for attachment to a gas bottle or container; and a method of producing a pulsed flow of gas from a container or source of said gas.

### FIELD OF THE INVENTION

This invention relates to an improved insect trap suitable for trapping of flying insects including mosquitoes, sand flies, wasps, fleas, midges and the like.

### BACKGROUND TO THE INVENTION

Conventional insect traps of one type are relatively compact and include a housing, a source of light located in the housing and a capture or immobilization medium such as a sheet having adhesive impregnated thereon or entrapment container for retention of flying insects after they have entered the housing through an opening thereof after being attracted by the light source. Such insect traps are described in U.S. Pat. Nos. 4,400,903, 4,332,100, 4,930,251, 5,231,792, 5,301,456, 5,365,690, 5,513,465, 5,915,948, 5,974,727, 6,502,347, 6,886,292 and U.S. Pat. No. 7,284,350. While these insect traps are relatively inexpensive, they are inefficient because a light source does not have the same attraction to flying insects as for example carbon dioxide which is a very strong attractant for mosquitoes for example who can detect carbon dioxide from a long distance away from the trap location i.e. about 70-100 metres away.

It was also well known to incorporate a fan or air blower in insect traps of the type described above which could produce a draught of air within the housing to force insects into an entrapment chamber or immobilization medium such as an adhesive impregnated sheet. However while the inclusion of the fan or air blower provided an increase in overall effectiveness in trapping ability they were not as efficient as insect traps which used carbon dioxide as an attractant lure. These types of insect traps are described in U.S. Pat. Nos. 4,127,961, 6,574,914, 6,840,003 and U.S. Pat. No. 7,191,560.

There was another type of conventional insect trap which used carbon dioxide as an attractant lure and in this case it was normally necessary to generate the carbon dioxide in situ. Thus in one form it was necessary to generate carbon dioxide by catalytic conversion from a hydrocarbon fuel such as propane. This is described for example in U.S. Pat. Nos. 6,145,243, 6,718,685, 6,779,296, 6,840,005, 6,892,492, 6,925,752 and U.S. Pat. No. 7,293,388. Other means of generating carbon dioxide include reacting acetic acid with baking soda as described in U.S. Pat. Nos. 4,506,473 and 6,920,716. Another method of generating or passing the carbon dioxide to the insect trap was to pass the carbon dioxide through a vertically extending exhaust tube to minimize cooling and minimize condensation of moisture as described in U.S. Pat. No. 6,662,489. In U.S. Pat. No. 5,382,422 reference is made to preparing and delivering a gas mixture of liquid chemical compounds such as octenol acetone soluble in liquid carbon dioxide to be used as an enhanced attractant for biting insects.

However it will be appreciated that such means of generating or supplying carbon dioxide to the insect traps were expensive but also complicated the overall structure of the insect trap. However a more relevant problem was that the carbon dioxide gas was supplied as a constant flow which was relatively ineffective in attracting insects to the trap.

It is therefore an object of the invention to provide an insect trap that is simple to operate and effective in use.

The insect trap of the invention includes a housing having located therein:

(i) a gas bottle or container
(ii) one or more modulators having a viscous medium to produce a pulsed flow of gas; and
(iii) a capillary tube interconnecting the gas bottle or container and a respective modulator wherein said capillary tube has a restricted zone to decrease the flow of gas therethrough whereby the pulsed flow of gas is caused to flow out of the housing at a greatly reduced rate compared to a flow rate that would be produced if the restricted zone was absent.
(iv) a support body in fluid communication with a gas bottle or container which has an internal passage for retaining the capillary tube wherein the capillary tube has a pair of ends which are each attached to an adjacent end of the internal passage and there is also provided a transverse passage oriented normally to the internal passage and said restricted zone is formed by a pair of screw threaded pressurizing devices each located in the transverse passage which each contact the capillary tube on opposed sides or locations thereof.

The housing is suitably compact and may have a central cavity or space for location of the gas bottle. A single modulator may be used or a plurality of modulators may also be used wherein each modulator contains an attractant lure specific to a particular winged insect. Thus for example, if three modulators are used the trap may be used for attraction of wasps, mosquitoes and sandflies as described hereinafter.

The housing may also be provided with a suitable insect immobilization device such as capture medium suitably in the form of paper or sticky paper located in a mounting frame which is releasably connected to an interior of the housing. Alternatively use may be made of an entrapment container. The housing may also include a plurality of grilles having air slots for entry of insects into a hollow interior of the housing. Suitably there may be provided a pair of grilles in a front wall of the housing and a pair of grilles located in a rear wall of the housing wherein each pair of grilles are located in side parts or wings of the housing symmetrically assigned with regard to the central cavity or space.

Preferably the housing has a top wall, bottom wall and side walls which are all formed from translucent or transparent material so that light from a light assembly located within the housing may be refracted as it passes through the walls of the housing. Alternatively the housing may be predominantly formed from the translucent or transparent material.

The light assembly is preferably powered by a solar panel which is connected to or located adjacent an LED unit.

In another aspect of the invention there is provided a method of producing a pulsed flow of gas such as carbon dioxide from a container or source of said gas which includes the steps of:

(i) reducing the flow rate of the gas by passing the gas through a capillary tube having at least on restricted zone; and
(ii) passing said gas through one or more modulators containing a viscous medium to produce the pulsed flow of gas.

### DETAILED DESCRIPTION OF THE PREFERRED EMBODIMENTS

Reference may now be made to a preferred embodiment of the insect trap of the invention as shown in the attached drawings wherein:

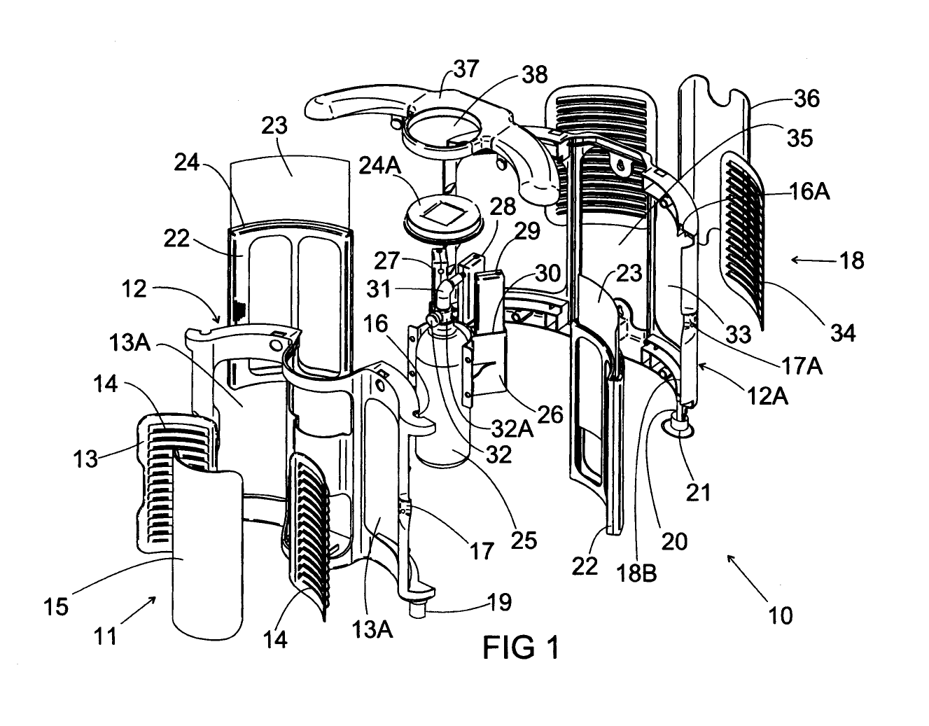

FIG. 1 is an exploded perspective view of a front side of the insect trap;

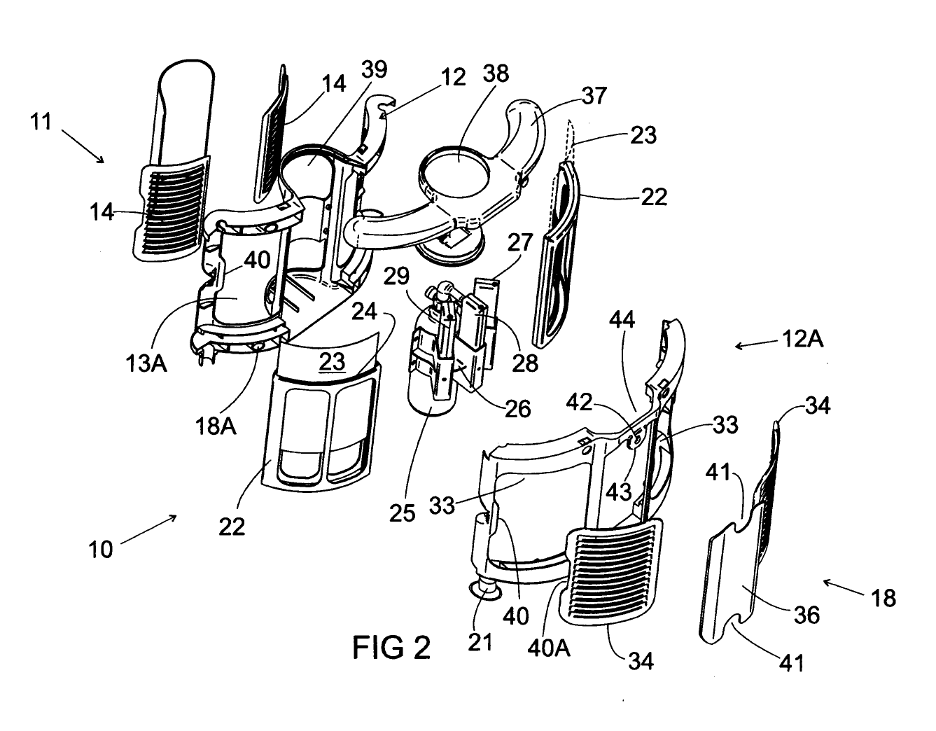

FIG. 2 is an exploded perspective view of a rear side of the insect trap shown in FIG. 1;

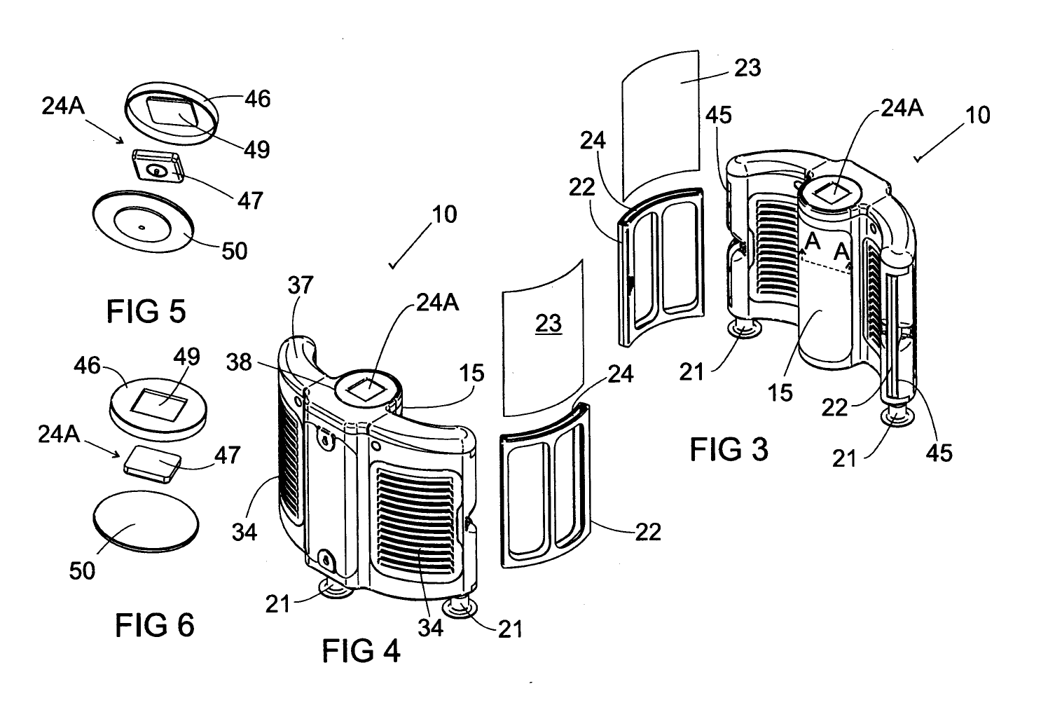

FIG. 3 is a front perspective and assembled view of the insect trap shown in FIG. 1 showing the capture frame and associated capture sheet removed therefrom for reasons of clarity;

FIG. 4 is a similar view shown in FIG. 3 but showing a rear assembled view of the fly trap shown in FIG. 3;

FIG. 5 is an exploded underside view of the light assembly incorporated in the fly trap shown in FIG. 1;

FIG. 6 is a similar view to that shown in FIG. 5 from the top of the light assembly;

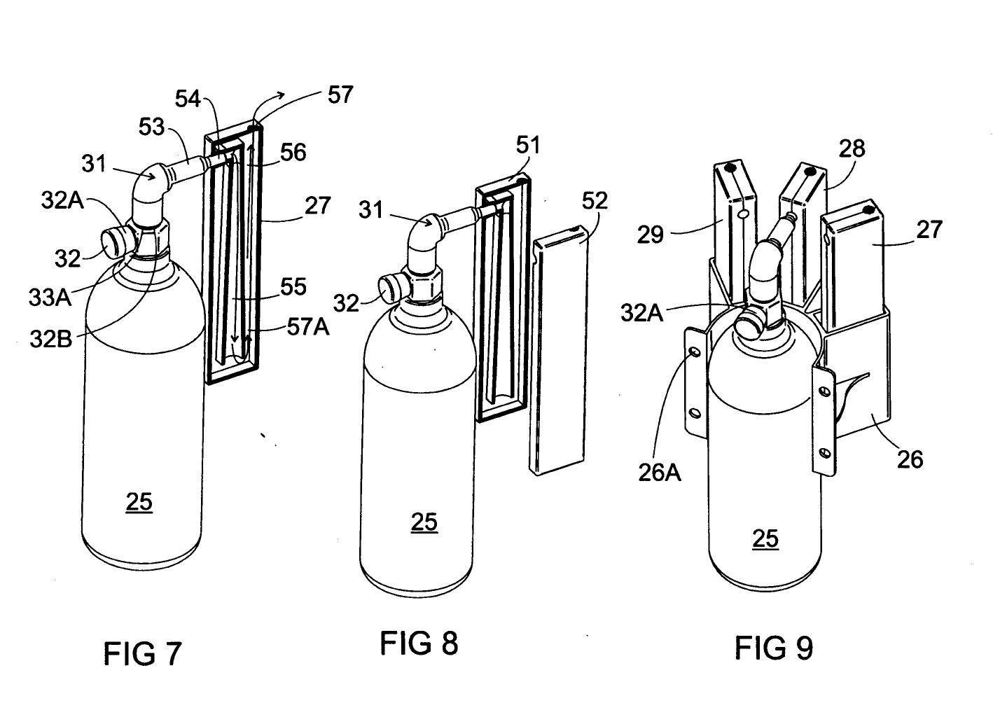

FIGS. 7, 8 and 9 are different perspective views of the gas bottle and associated modulators which are used in the insect trap shown in FIG. 1;

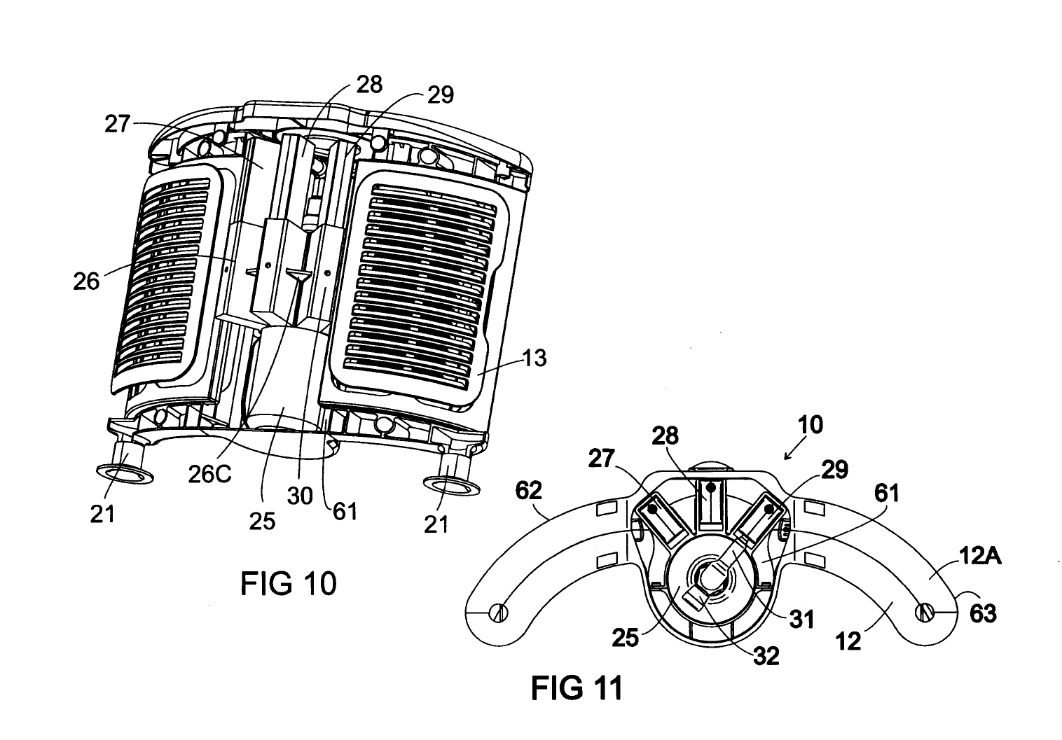

FIG. 10 is a perspective view of an assembled insect trap shown in FIG. 1 with a transparent cover removed showing incorporation of the gas bottle and modulators shown in FIGS. 7, 8 and 9;

FIG. 11 is a plan view of the insect trap shown in FIG. 10 with a top plate removed again showing incorporation of the gas bottle and associated modulators shown in FIGS. 7, 8 and 9;

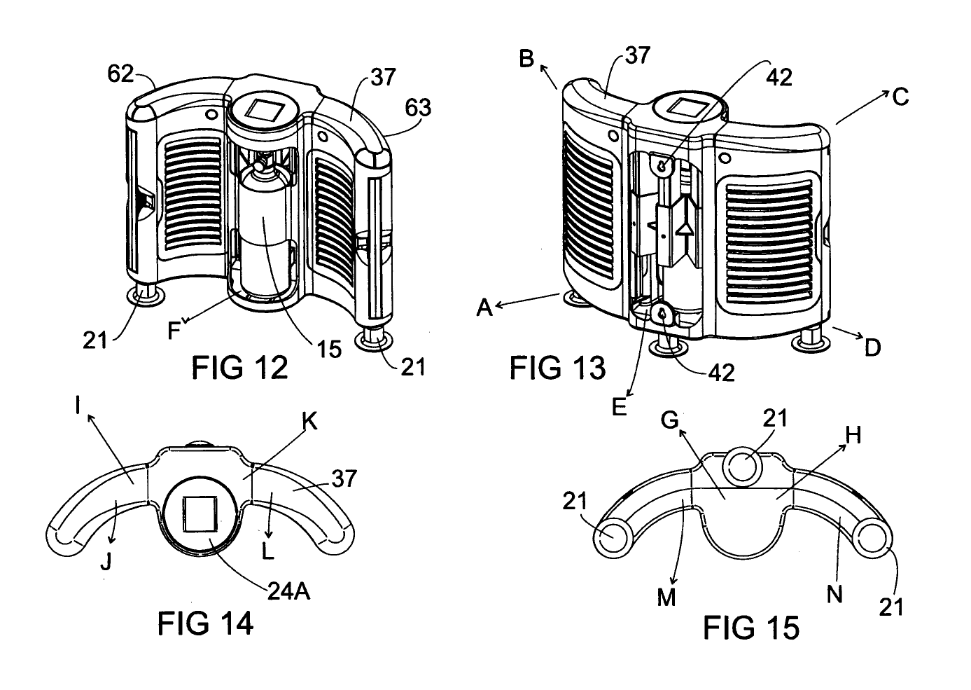

FIGS. 12, 13, 14 and 15 show various views of the assembled insect trap of the invention;

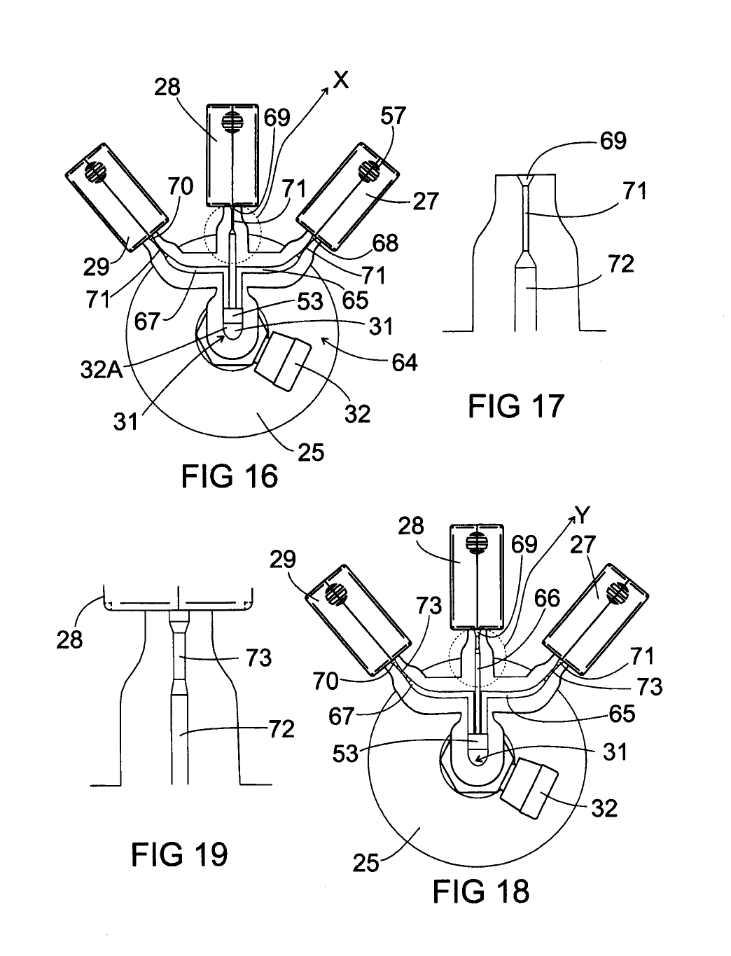

FIGS. 16-19 show details of the capillary tubes connecting each modulator to the gas bottle; and

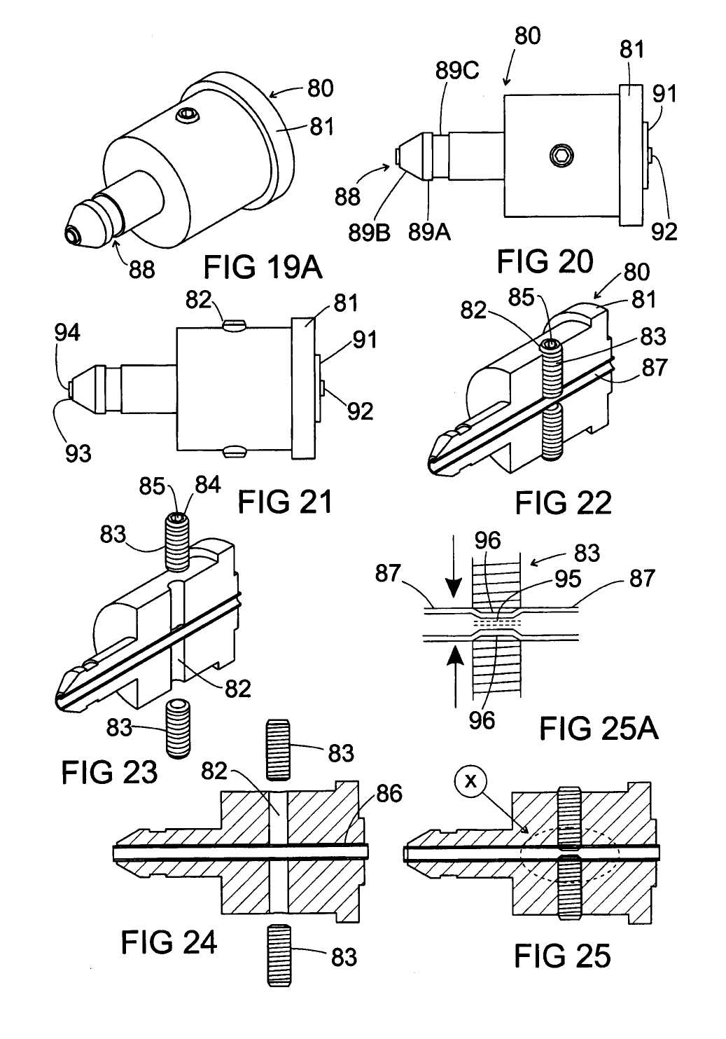

FIGS. 19A-27 refer to another embodiment of the invention in relation to formation of the restricted zone.

In FIG. 1 there is shown insect trap 10 having a front wall assembly 11 having peripheral frame 12; grilles 13 each having air slots 14, a front transparent cover 15 bounded by grilles 13 on each side, and locating projections or sockets 16 and 17 which engage with corresponding projections or sockets 16A and 17A shown on peripheral frame 12A of rear wall assembly 18. Each grille 13 may engage in snap fit or interference fit with associated apertures 13A located in frames 12 and 12A.

Peripheral frame 12 also has bottom locating projections 19 which engage with corresponding projections 20 on peripheral frame 12A of rear wall assembly 18 so that each wall assembly 11 and 18 may be snap fitted together so as to be totally supported by legs 21 of rear wall assembly 18. There are also provided additional locating projections 18A on peripheral frame 12 shown in FIG. 2 which engage with corresponding locating sockets 18B on peripheral frame 12A.

There is also shown capture plates or frames 22, capture sheets 23 which are slidably retained within an internal space 24 of each capture plate 22, light assembly 24A, gas bottle 25, a support frame 26 for modulators 27, 28 and 29 which are each retained in associated sockets 30 of support frame 26. There is also provided manifold 31 interconnecting gas bottle 25 and each modulator 27, 28 and 29 so that gas bottle 25 is in fluid communication with a hollow interior of each modulator 27, 28 and 29. There is also provided an actuator button or a rotary on-off control 32 for actuating flow of gas from gas bottle 25 to modulators 27, 28 and 29. On-off control 32 may be connected to a needle valve, ball valve or any other valve 32A for controlling the flow of gas from bottle 25.

Rear wall assembly 18 also includes grilles 34 each engageable with associated apertures 33 of peripheral frame 12A in a similar manner to grilles 13 engaging with apertures 13A. There is also shown a rear plate or cover 36 made up of transparent material which covers an access window or space 35 to gas bottle 25 and associated modulators 27, 28 and 29. There is also provided top plate 37 having aperture 38 for retention of light assembly 24A.

In FIG. 2 there is shown recess 39 in peripheral frame 12 for accommodation of gas bottle 25 and associated modulators 27, 28 and 29 and retaining lugs 40 in aperture 13A for retention of grilles 34 whereby lugs 40 engage with slots 40A. There are also provided slots 41 in rear plate 36 which engage with retaining apertures 42 in lugs 43. Peripheral frame 12A is also provided with mating recess 44 which mates with corresponding recess 39 to provide a central compartment 61 shown in FIG. 10 to enclose gas bottle 25 and modulators 27, 28 and 29.

In FIGS. 3-4 there is shown an assembled view of insect trap 10 from a front view and rear view respectively. It will be noted that each capture frame 22 and associated capture sheet 23 are retained in an associated slot 45 of insect trap 10.

It will also be appreciated from a view of FIGS. 3-4 that insect trap 10 instead of being formed from interconnecting front and rear wall assemblies 11 and 18 as shown in FIGS. 1-2 can be made as a one piece moulding from suitable transparent or translucent plastics material.

In FIGS. 5-6 there is shown light assembly 24A having housing 46, solar panel 49, LED unit 47 and plastics refraction plate 50 wherein light from LED unit 47 will be refracted as it passes through plate 50.

In FIGS. 7-9 there is shown gas bottle 25 and associated modulators 27, 28 and 29. Each modulator has a pair of opposed housing components 51 and 52 shown in FIG. 8 with manifold 31 having an intermediate part 53 and inlet component or nozzle 54 being of smaller diameter than intermediate part 53. Inlet component or nozzle 54 has a bore of about 0.50 to 1.00 mm and carbon dioxide gas from gas bottle 25 may flow continuously into inner passage 55 of modulator 27 where it may encounter an attachment medium 57A which may contain a viscous component such as honey. Suitable attractant lures for the insect may include a variety of attractant lures as described in International Publication WO/2010/012031 which is reproduced herein in its entirety. Thus for example, suitable attractant lures may be selected from suitable food grade constituents that with the aid of natural moisture contained in the medium produce a certain amount of carbon dioxide that will supplement the flow of gas from gas bottle 25: Volatile attractant lures may include lactic acid, octenol including 1-octen-3-ol, L-lysine, acetone valeric acid and kairomones. Instead of honey molasses or syrups may form examples of viscous substances that may be combined with the volatile attractant lure. Suitable viscous substances may have a viscosity in the range of 500-30,000 cp. There also may be used other attractant lures which are a food grade component such as mushroom extract, sugar, ammonium bicarbonate and sodium chloride. Such components can be dissolved in a suitable solvent which be cider vinegar, red wine or white wine.

While only one modulator 27 may be used within the scope of the invention it is preferred that specific attractant lures may be differently formulated to attract different biting insects and that such different attractant lures may be used in modulators 28 and 29. Thus for example lures specific for paper wasps or yellow jacket species may be used. Such lures contain as one component acetic acid and as another component a compound selected from isobutanol, racemic 2-methyl-1-butanol, S-(−)-2-methyl-1-butanol, 2-methyl-2-propanol, heptyl butyrate and butyl butyrate. This attractant lure is described in U.S. Pat. No. 6,083,498. Another attractant lure which may be used in modulator 29 may be an attractant lure for sand flies as described in U.S. Pat. No. 4,886,662 which contains alpha-terpineol as an active component.

However it will be appreciated that each of modulators 27, 28 and 29 will have a viscous component which will have the important ability of causing carbon dioxide to be expelled from outlet 57 of outer passage 56 in a pulsed or intermittent flow so that separate plumes of attractant lure and CO2 may be expelled through grilles 13 and 34 as described in International Publication WO/2010/012031. The flow of gas in modulator 27 is shown by the arrows in full outline in FIG. 7. Modulator support frame 26 also includes attachment apertures 26A for attachment to frame 12 or 12A by suitable fasteners (not shown).

FIG. 7 also shows a manifold or manifold assembly 31 which may be directly attached to an outlet 33A of gas bottle 25 by welding or by screw threaded engagement at 33B.

In FIG. 10 there is shown the insect trap 10 after removal of transparent cover 15 and also illustrating compartment 61 for gas bottle 25 arid associated modulators 27, 28 and 29. Each of modulators 27, 28 and 29 are contained in associated holders 30. Also shown are webs 26C interconnecting holders 30.

In FIG. 11 it is shown that gas bottle 25 and associated modulators 27, 28 and 29 in compartment 61 are centrally located and wings or side parts 62 and 63 are symmetrically orientated in regard to compartment 61.

FIGS. 12-13 show the presence of transparent front cover 15 and transparent rear cover 36 for gas bottle 25 and associated modulators 27, 28 and 29. Each of side parts 62 and 63 may be formed from translucent material so that light from light assembly 24A may be totally visible through covers 15 and 36 and side parts 62 and 63. In fact side parts 62 and 63 may be formed from refractive material so that light from light assembly 24A is bent as it passes through top wall 37 and peripheral frames 12 and 12A and this will provide a greater attraction to insects. In fact light from light assembly 24A may extend from trap 10 in all directions as shown by arrows A, B, C, D and E in FIG. 13 and arrow F in FIG. 12.

FIGS. 14 and 15 also show that top plates or cover 37 and base wall 64 may be also formed from translucent material so that light from light assembly 24A may also shine through top cover 37 and base wall 64 as shown by arrows I, J, K, L, G, H, M and N.

It will also be appreciated that legs 21 may be replaced or fitted into spikes (not shown) for retention of insect trap 10 within the ground if desired.

In FIG. 16 there is shown a sectional view through trap 10 through line A-A shown in FIG. 3 in top plan. There is shown an internal mechanism 64 of conduits whereby carbon dioxide is transported to modulators 27, 28 and 29 through capillary tubes 65, 66 and 67 which communicate with each of modulators 27, 28 and 29 through inlets 68, 69 and 70. Each capillary tube 65, 66 and 67 is crimped or twisted as shown by crimped or restricted zone 71 in FIGS. 16-17 and the crimped or restricted zone 71 has a diameter of from 0.005 to 0.2 mm compared to an unrestricted part 72 of capillary tube 65, 66 and 67 which can have a diameter of 0.025 to 1.25 mm. The restricted zone 71 may have a gas flow of 5-39 g of gas per day and more suitably 18 g per day.

It will also be appreciated that crimped or restricted zone 71 will greatly increase frictional contact of the gas with an internal surface of restricted zone 71 and this will greatly reduce the flow of gas through restricted zone 71. The length of restricted zone 71 may also vary from 10-125 mm. Obviously the greater the length of restricted zone 71 the greater reduction in gas flow may be achieved.

It is also preferred that multiple restricted zones 71 may be used but it is preferred that there is only a single restricted zone 71.

Instead of using a twisted or crimped zone 71 as shown in FIGS. 16-17 a restricted zone 73 may be used which is of much smaller diameter than unrestricted part 72 as shown in FIGS. 18-19.

Reference may be made to another embodiment of the invention as shown in FIGS. 19A-27 wherein reference is made to an adjustment body which may produce the restricted zone discussed above but such restricted zone will be produced within a capillary tube by use of one or more pressurizing devices which upon contact with the capillary tube will produce the restricted zone but upon withdrawal of the pressurizing device(s) from the capillary tube the restricted zone may no longer be present. This embodiment takes advantage of the natural resilience or elasticity of the material which forms the capillary tube which for example may be copper or plastics material. Thus the pressurizing device(s) may only make bearing contact with the capillary tube to produce the restricted zone and thus the flow rate of gas can be calculated as may be required. The flow rate may be measured by passing the capillary tube or adjustment body under water to gauge the size of the bubbles being generated. Thus it will be appreciated that such restricted zone may not be permanent but may be temporarily caused by contact with the pressurizing devices which may be a plurality or pair of adjustment nuts for example. By opening up the transverse dimension or diameter of the capillary tube this may also remove impurities from the gas after passage through the restricted zone.

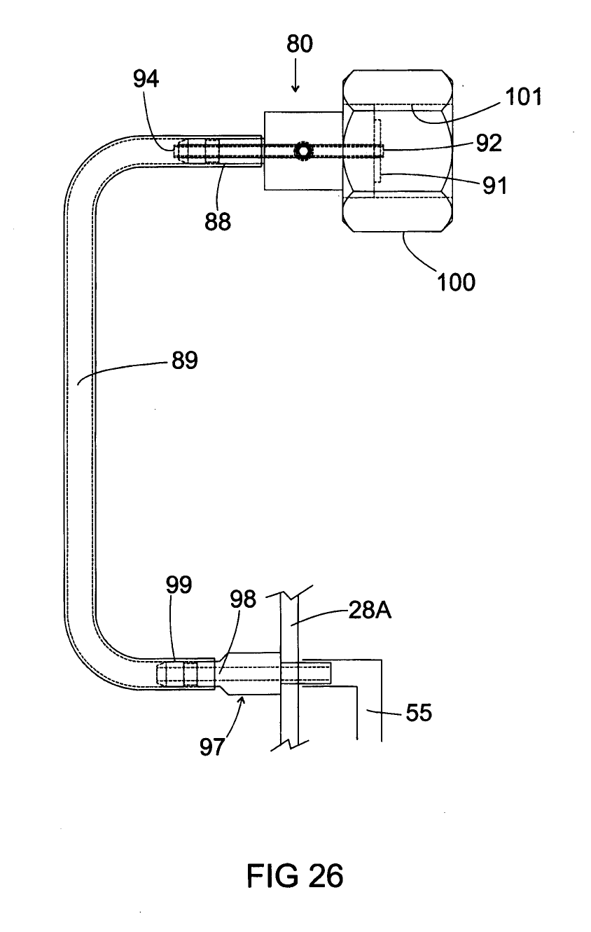

In FIGS. 19A-25 reference is made to an adjustment body 80 having an end flange 81, transverse passage 82 having a pair of adjustment nuts 83 each having a respective outer end 84 having a hexagonal shaped recess 85 for engagement by a suitable tool such as an Allan key (not shown) or other type of hexagonal key. The adjustment body 80 also includes a longitudinal passage 86 which contains the capillary tube 87. There is also provided a spigot 88 which may be used for engagement with a hose 89 shown in FIG. 26 for transmission of carbon dioxide gas to a modulator housing 28. The capillary tube 87 may be made of copper or similar material which extends from one end 91 of adjustment body 80 and which is welded thereto shown at 92. The other end of capillary tube 87 extends through spigot 88 and is welded to end 93 of spigot 88 as shown at 94.

Spigot 88 is also provided with a bearing ridge 89A, tapered end 89B and flat 89C for retention of hose 89 shown in FIG. 26. FIG. 25A shows formation of restricted zone 95 which is formed in capillary tube 87 by pressure or the force generated by flat bearing faces 96 of each adjustment nut 83 on capillary tube 87.

FIG. 26 shows connection of hose 89 to spigot 88 of adjustment body 80. Hose 89 is also connected to a connection body or nozzle 97 having a hollow bore 98 which extends through a side wall 28A of modular 28 as shown in FIG. 26. Connection body 97 may be similar to body 53 shown in FIG. 7 having inlet 54. Hose 89 may be connected to spigot 99 in a similar manner as connection of hose 89 to spigot 88 described above. Gas flows through hollow bore 98 to inner tube 55 of modulator 28.

FIG. 26 also shows how adjustment body 80 may have connected thereto a large hexagonal nut 100 which has a threaded internal part 101 for connection to a suitable inlet of a gas bottle (not shown).

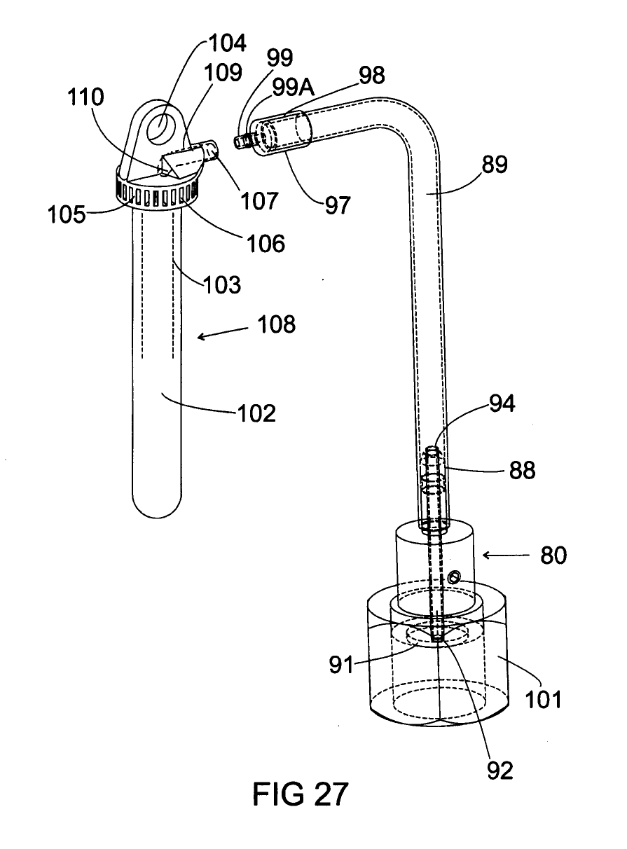

FIG. 27 shows another arrangement involving use of adjustment body 80 in being connected to the modulator 108 described in International Publication WO2010/012031 which has a housing component 102 and inner tube or insertion tube 103 which also has a finger aperture 104, ribs 05 separated by spaces or gaps 106, and socket 107 for connection with connection body or nozzle 97 having a hollow bore 98 wherein spigot 99 having O-ring 99A is engageable in hollow bore 109 of socket 107. Modulator 108 also has reinforcing ribs 110. Bore 98 is in flow communication with internal passage 103 as shown. Hose 89 is connected to connector body 97 and at its other end is adjustment body 80 connected to hexagonal nut 100 as shown in FIG. 26.

Thus another aspect of the invention provides a conduit assembly interconnecting a modulator as shown in WO 2010/012031 or modulator 28 wherein the conduit assembly at one end has a connector body fitted to the modulator for discharge of gas such as CO2 into a hollow interior of the modulator to produce a pulsed flow of gas and the conduit assembly at another end is attached to an adjustment body having a restricted zone in a capillary tube for reducing the flow rate of the gas wherein the adjustment body is connected to a gas source such as a gas bottle. The invention may also include within its scope the adjustment body per se.

It will be appreciated with the advent of the present invention that a small gas bottle of carbon dioxide of around 500 g may last for a month 24/7 because of the fact that a very small pulsed flow of gas is produced in bubbles or plumes interposed between plumes of attractant lure as shown in International Publication WO/2010/012031. The insect trap of the invention does not need to be connected to an electrical source of power such as the mains or a battery. Also a gas regulator is not required. Also by the use of a very simple mechanism as shown in FIGS. 18-19 complicated connection mechanisms to a source of carbon dioxide as described in the prior art discussed above are not required or needed.

The invention in another aspect may include a method of controlling flow of carbon dioxide from a container of carbon dioxide which includes the steps of:

(i) attaching a manifold assembly containing a capillary tube which has a restricted zone to an outlet of the container; and
(ii) causing carbon dioxide to flow through the manifold assembly at a reduced flow rate compared to the situation when the restricted zone is not present.

The invention also included within its scope the manifold assembly per se.

1. An insect trap including a housing having located therein:
(i) a gas bottle or container
(ii) one or more modulators having a viscous medium to produce a pulsed flow of gas
(iii) a capillary tube interconnecting the gas bottle or container and a respective modulator wherein said capillary tube has a restricted zone to decrease the flow of gas therethrough whereby the pulsed flow of gas is caused to flow out of the housing at a greatly reduced rate compared to a flow rate that would be produced if the restricted zone was absent; and
(iv) a support body in fluid communication with a gas bottle or container which has an internal passage for retaining the capillary tube wherein the capillary tube has a pair of ends which are each attached to an adjacent end of the internal passage and there is also provided a transverse passage oriented normally to the internal passage and said restricted zone is formed by a pair of screw threaded pressurizing devices each located in the transverse passage which each contact the capillary tube on opposed sides or locations thereof.

2. The insect trap as claimed in claim 1 wherein the viscous medium has one or more attractable lures for insects.

3. The insect trap as clamed in claim 1 wherein the housing has a central cavity or space for location of the gas bottle or container.

4. The insect trap as claimed in any one of claim 1 wherein a single modulator is contained within the housing.

5. The insect trap as claimed in any one of claim 2 wherein a plurality of modulators are used wherein each modulator contains an attractant specific to a particular winged insect.

6. The insect trap as claimed in any one of claim 1 wherein the housing contains an insect immobilization device or entrapment container releasably mounted therein.

7. An The insect trap as claimed in claim 6 wherein the immobilization device has capture medium located in a mounting frame which is releasably mounted to an interior of the housing.

8. The insect trap as claimed in any one of claim 1 wherein the housing has one or more grilles having air slots for entry of insects into the housing.

9. The insect trap as claimed in claim 8 wherein said housing has a pair of said grilles located in a front wall and a rear wall of the housing.

10. The insect trap as claimed in any one of claim 1 wherein the housing is formed from predominantly transparent or translucent material whereby light from inside the housing may be refracted as it passes through the housing.

11. The insect trap as claimed in claim 10 wherein the housing has a top wall, bottom wall and a continuous side wall all formed from said transparent or translucent material.

12. The insect trap as claimed in claim 10 wherein the housing has a light assembly located within the housing.

13. The insect trap as claimed in claim 12 wherein the light assembly includes a solar panel and a LED unit wherein the LED unit is powered by the solar panel.

14. The insect trap as claimed in any one of claim 1 wherein the restricted zone is formed by crimping or twisting the capillary tube.

15. The insect trap as claimed in any one of claim 1 wherein the restricted zone has a diameter of from 0.005 to 0.2 mm compared an unrestricted part of the capillary tube having a diameter of 0.025 to 1.25 mm.

16. The insect trap as claimed in any one of claim 1 wherein the restricted zone is adjustable in regard to diameter or lateral dimension.

17. The insect trap as claimed in claim 16 wherein said restricted zone is formed temporarily within said capillary tube by use of one or more screw threaded pressurising devices which upon contact with the capillary tube will produce the restricted zone which is adjustable but upon withdrawal of the pressurising devices the restricted zone will no longer be present.

18. (canceled)

19. (canceled)

20. (canceled)

21. (canceled)

22. (canceled)

23. A conduit assembly connectable to a modulator at one end and connectable to a gas bottle or container at another end, said conduit assembly having (i) a connector body fittable to the modulator for discharge of gas such as carbon dioxide into a hollow Interior of the modulator, and (ii) a support body in fluid communication with the gas bottle or container having a capillary tube which incorporates a restricted zone for reducing the flow rate of the gas, said support body having an internal passage for retaining the capillary tube wherein the capillary tube has a pair of ends which are each attached to an adjacent end of the internal passage and there is also provided a transverse passage oriented normally to the internal passage and said restricted zone is formed by a pair of screw threaded pressurizing devices each located in the transverse passage which each contact the capillary tube on opposed sides or locations thereof.

24. A support body in use being in fluid communication with a gas bottle or container having a longitudinal bore or internal passage and a capillary tube located in said longitudinal bore or internal passage and a passage located transverse to the longitudinal bore or internal passage containing a pair of screw threaded pressurizing devices for pressurizing the capillary tube for forming a restricted zone wherein the capillary tube has a pair of ends which are each attached to an adjacent end of the longitudinal bore or internal passage and said restricted zone is formed by each pressurizing device contacting the capillary tube on opposed sides or locations thereof.

25. A method of producing a pulsed flow of gas from a container or source of said gas which includes the steps of:
(i) reducing the flow rate of the gas by passing the gas through a support body as claimed in claim 19; and
(ii) passing said gas through one or more modulators containing a viscous medium to produce a pulsed flow of gas.

26. A method of controlling flow of carbon dioxide from a container of carbon dioxide which includes the steps of:
(i) attaching a manifold assembly containing a support body as claimed in claim 19 to an outlet of the container.
(ii) causing carbon dioxide to pass through the manifold assembly at a reduced flow rate compared to the situation if the or each restricted zone was not present.

27. A method of controlling flow of carbon dioxide or other gas from a container of carbon dioxide or other gas wherein carbon dioxide or the other gas is passed through a capillary tube having a diameter of 0.005 to 0.2 mm wherein said capillary tube is mounted in an internal passage of a support body in fluid communication with the container; said capillary tube having a pair of ends each attached to an adjacent end of the internal passage characterized in that the said capillary tube has a restricted zone caused by a pair of screw threaded pressurizing devices which are each located in a transverse passage of the support body in communication with the internal passage whereby each pressurizing device contacts the capillary tube on opposed sides or locations thereof to form said restricted zone which has an internal diameter of 0.025 to 1.25 mm whereby gas flow through the restricted zone occurs at a minute rate of 5-39 g of gas per day.
